(19) United States
(12) Patent Application Publication
(10) Pub. No.: US 2014/0202146 A1
(43) Pub. Date: Jul. 24, 2014

(54) METHOD FOR OPERATING A WAVE ENERGY CONVERTER

(71) Applicants: Benjamin Hagemann, Bad Segeberg (DE); Nik Scharmann, Bietigheim-Bissingen (DE); Daniel Seiler-Thull, Stuttgart (DE); Michael Hilsch, Stuttgart (DE)

(72) Inventors: Benjamin Hagemann, Bad Segeberg (DE); Nik Scharmann, Bietigheim-Bissingen (DE); Daniel Seiler-Thull, Stuttgart (DE); Michael Hilsch, Stuttgart (DE)

(73) Assignee: Robert Bosch BmbH, Stuttgart (DE)

(21) Appl. No.: 14/126,817

(22) PCT Filed: Apr. 24, 2012
(86) PCT No.: PCT/EP2012/001752

§ 371 Date: Mar. 31, 2014

(30) Foreign Application Priority Data
Jun. 17, 2011 (DE) 10 2011 105 177.9

(51) Int. Cl. F03B 3/12

(52) U.S. Cl. CPC F03B 3/12
USPC 60/495; 415/1

(57) ABSTRACT

A method for operating a wave energy converter for converting energy from a wave motion of a fluid into a different form of energy includes at least one rotor and at least one energy converter that is coupled to the at least one rotor. A first torque that acts on the at least one rotor is generated by the wave motion, and a second torque (M1) that acts on the at least one rotor is generated by the at least one energy converter. The second torque (M1) is specified during a control of the energy converter.

The present invention relates to a method for operating a wave energy converter, and to a wave energy converter.

### PRIOR ART

Various devices for converting energy from wave motions in bodies of water into useful energy are known from the prior art; these devices can be used on the high sea or close to the shore. An overview of wave power generators is given, for example, by G. Boyle, “Renewable Energy”, Second Edition, Oxford University Press, Oxford 2004.

Differences arise from, inter alia, the way in which the energy is extracted from the wave motion. Thus, there are known buoys, or floating bodies, which float on the surface of the water, their rise and fall driving, for example, a linear generator. In the case of another machine concept, the so-called “Wave Roller”, a flat drag element is attached to the seabed and is tilted back and forth by the wave motion. The energy of motion of the drag element is converted, for example, into electrical energy, in a generator. In such oscillating systems, however, it is only possible to achieve a maximum energy yield of 0.5, such that their efficiency is generally not satisfactory.

Wave energy converters that are of interest in the context of the present invention are those, in particular, that are disposed substantially below the water surface and in which a crankshaft or rotor shaft is made to rotate by the wave motion.

In this connection, there is known from the publication by Pinkster et al., “A rotating wing for the generation of energy from waves”, 22^{nd} International Workshop on Water Waves and Floating bodies (IWWWFB), Plitvice, 2007, a machine concept in which the lift of a lift device subjected to flow, i.e. a coupling body generating a hydrodynamic lift, is converted into a rotational motion.

Further, US 2010/0150716 A1 discloses a system composed of a plurality of high-speed rotors having lift devices, in which the rotor period is less than the wave period, and a separate profile adjustment is performed. It is intended that, as a result of an appropriate adjustment of the lift devices, which, however, is not disclosed in greater detail, resultant forces upon the system are generated, which can be used for various purposes. A disadvantage of the system disclosed in US 2010/0150716 A1 is the use of Voith-Schneider-type high-speed rotors, which require an elaborate system for adjustment of the lift devices. The latter have to be adjusted continuously within a not inconsiderable angular range, in order to be adapted to the respectively prevailing incident flow conditions. Moreover, in order to compensate the forces, resulting from a rotor moment and generator moment, acting on the individual rotors, it is always necessary for a plurality of rotors to be at defined distances in relation to each other.

Accordingly, the invention is based on the object of improving rotating wave energy converters, in particular in respect of a greater energy yield and a less elaborate design and/or a less elaborate control system requirement.

### Disclosure of the Invention

Against this background, the present invention proposes a method for operating a wave power generator having the features of claim 1. Advantageous developments are provided by the dependent claims and by the description that follows.

### Advantages of the Invention

The invention creates a possibility for achieving an energy yield from the machine that is as great as possible over a certain time window. For this, in differing embodiments, a variety of quantities are selectively specified within the machine. According to the invention, for the purpose of controlling the energy conversion, a second torque is selectively specified, which is provided by an energy converter coupled to the rotor. In the context of this application “specify” is understood to mean both open-loop control (also referred to as setting or precontrol) and—more preferably—closed-loop control (also referred to as feedback control). The energy conversion control serves, in particular, to deliver a desired energy over a desired time period.

In a preferred embodiment, therefore, the energy conversion control also influences the alignment of a housing, or frame (stator), and of the coupling bodies in relation to the surrounding flow field, such that these are optimal (in terms of the desired energy yield) over the time window under consideration.

In a further preferred development, the energy conversion control is linked to a position control, in order to prevent unwanted changes in the position (x, y and z coordinates, and turning \vec{θ} about all three axes) of the machine, such that there is no resultant danger to the machine and/or to the environment. The invention also makes it possible to selectively shift or turn the machine in space and/or to stabilize it.

The invention presented here considers, quite generally, machines that have a rotatory principle of operation, e.g. including converters having a plurality of rotors, e.g. as represented in FIG. 5. The statements that follow therefore apply, in principle, to wave energy converters having one or more rotors.

Provided overall, therefore, is a wave energy converter having at least one, as explained below, rotor rotating, advantageously, in synchronism or largely in synchronism with a wave (orbital) motion or flow, for the purpose of converting energy from a body of water having waves, which wave energy converter is advantageous in respect of its energy yield and control system, and with which, moreover, when appropriately operated, (resultant) forces can be influenced and utilized for influencing the system as a whole. By means of such a wave energy converter, with appropriate configuration and operational control, it is possible to achieve virtually a complete extinction, and therefore utilization, of the incident wave. This applies, in particular, to monochromatic waves. Owing to the synchronous or largely synchronous operation, the lift devices used in a corresponding wave energy converter, i.e. the coupling bodies, which are designed to convert a wave motion into a lift force, and therefore into a torque of a rotor, do not have to be adjusted, or they have to be adjusted only to a small extent, since a flow against a corresponding profile is in this case effected, over the entire rotation of the rotor carrying the profile, largely from one same direction of incident flow. Adaptation of an angle of attack γ, as in the case of the known Voith-Schneider rotors (also termed pitching), is therefore not necessary, but may be advantageous.

In sea waves, the water particles move on largely circular, so-called orbital paths (in the form of an orbital motion, or orbital flow, the two terms also being used synonymously). In this case, under a wave peak the wave particles move in the direction of propagation of the wave, under the wave trough they move contrary to the direction of the wave, and in the two zero crossings they move upward and downward, respectively. The direction of flow at a fixed point below the water surfaces (referred to in the following as a local, or instantaneous, incident flow) thus changes continuously, at a certain angular velocity O. In deep water, the orbital flow is largely circular; in shallow water, the circular orbitals increasingly become flat-lying ellipses. A flow can be superposed on the orbital flow.

The orbital radii are dependent on the immersion depth. They are maximal at the surface—here, the orbital diameter corresponds to the wave height—and decrease exponentially as the water depth increases. At a water depth of approximately half the wavelength, therefore, the energy that can be extracted is then only approximately 5% of that which can be extracted close to the surface of the water. For this reason, submerged wave energy converters are preferably operated close to the surface.

Advantageously, a rotor is provided, having a largely horizontal rotor axis and at least one coupling body. The rotor rotates, advantageously, in synchronism with the orbital flow, at an angular velocity ω, and is driven by the orbital flow, by means of the at least one coupling body. In other words, the wave motion of the water or, more precisely, its orbital flow, generates a torque (referred to as a “first torque” or “rotor torque/(turning) moment” in the context of this invention), which acts upon the rotor. If the period of the rotational motion of the rotor and that of the orbital flow correspond, at least to a certain extent (see below concerning the term “synchronism” used here), then, apart from the mentioned effect of depth, and effects of width in the case of large rotor diameters, a constant local incident flow is always obtained at the coupling body. As a result, energy can be extracted continuously from the wave motion, and converted by the rotor into a useful torque.

The term “coupling body” in this context is to be understood to mean any structure by which the energy of an incident-flow fluid can be coupled into a rotor motion, or a corresponding rotor moment. As explained below, coupling bodies may be realized, in particular, as lift devices (also referred to as “foils”), but also drag devices.

The term “synchronism” in this case may denote a rotor rotational motion as a result of which, at each instant, a complete correspondence ensues between the position of the rotor and the direction of the local incident flow that arises from the orbital flow. Advantageously, however, a “synchronous” rotor rotational motion can also be effected in such a manner that a defined angle, or a defined angular range (i.e. the phase angle is held within the angular range over one revolution) is obtained between the position of the rotor, or at least of a coupling body disposed on the rotor, and the local incident flow. A defined phase offset, or phase angle Δ, is thus obtained between the rotor rotational motion ω and the orbital flow O. In this case, the “position” of the rotor, or of the at least one coupling body disposed on the rotor, can always be defined, for example, by a notional line through the rotor axis and, for example, the rotation axis or the center of gravity of a coupling body.

Such a synchronism can be derived directly, in particular for monochromatic wave states, i.e. wave states that have a continuously constant orbital flow O. However, under real conditions, i.e. in real sea states, in which the orbital velocity and orbital diameter change as a result of mutual superposition of waves, as a result of wind influence and the like (so-called multichromatic wave states), provision can also be made such that the machine is operated at an angle, in relation to the respectively active incident flow, that is constant only within a certain scope. In this case, an angular range can be defined, within which the synchronism can still be regarded as being maintained. This can be achieved through appropriate control measures, including the adjustment of at least one coupling body for generating the aforementioned first torque and/or a second torque of the energy converter that has a braking or accelerating effect. In this case, there is no need for all of the coupling bodies to be adjusted, or to have a corresponding adjustment facility. In particular, there is no need for synchronous adjustment of a plurality of coupling bodies.

Alternatively, however, provision may also be made to dispense with complete synchronism, in which the incident flow on the at least one coupling body is always effected locally from the same direction. Instead, the rotor can be synchronized to at least one main component of the shaft (e.g. a main mode of superposed waves), and consequently intermittently lead or lag the local flow. This can be achieved through corresponding adjustment of the first and/or second torque. Such operation is also still included under the term “synchronism”, as is a fluctuation of the phase angle within certain ranges that results in the rotor being intermittently able to undergo an acceleration (positive or negative) in relation to the wave phase.

The rotational speed of a “synchronous” or “largely synchronous” rotor therefore corresponds approximately, i.e. within certain limits, to the wave rotational speed prevailing at a particular time. Deviations are not cumulative in this case, but are largely compensated mutually or over time or over a certain time window. An essential aspect of a control method for a corresponding converter may consist in maintaining the explained synchronism.

Particularly preferably, coupling bodies are used from the class of lift devices that, in the case of an incident flow at an incident flow angle a, in addition to generating a drag force in the direction of the local incident flow generate, in particular, a lift force directed substantially perpendicularly in relation to the incident flow. These may be, for example, lift devices having profiles according to the NACA Standard (National Advisory Committee for Aeronautics), but the invention is not limited to such profiles. Particularly preferably, Eppler profiles may be used. In the case of a corresponding rotor, the local incident flow and the incident flow angle a associated therewith results in this case from superposition of the orbital flow v_{wave} in the previously explained local, or instantaneous, wave incident flow direction, the rotational speed of the lift device vᵣₒₜₒᵣ at the rotor, and the angle of attack γ of the lift device. The alignment of the lift device can therefore be optimized to the locally existing incident flow conditions, in particular through adjustment of the angle of attack γ of the at least one lift device. Furthermore, it is also possible to use flaps similar to those on aircraft wings and/or to change the lift profile geometry (so-called “morphing”) in order to influence the incident flow. The said changes are to be included under the term “shape changing”.

The aforementioned first torque can therefore be influenced, for example, by means of the angle of attack γ. It is known that, as the incident flow angle a increases, the resultant forces upon the lift device increase, until a drop in the lift coefficient is to be observed at the so-called stall limit, at which a flow separation occurs. The resultant forces likewise increase as the flow speed increases. This means that the resultant forces, and consequently the torque acting upon the rotor, can be influenced as a result of changing the angle of attack γ and, associated therewith, the incident flow angle a.

This aforementioned second moment, also referred to in the following as a “generator moment”, likewise affects the rotational speed vᵣₒₜₒᵣ and thereby likewise influences the incident flow angle a. In conventionally operated energy generating machines, the second moment constitutes a braking moment that results from the interaction of a generator rotor with the associated stator and that is converted into electrical energy. A corresponding energy converter in the form of a generator can also be operated by motor, however, at least during certain periods, such that the second moment can also act in the form of an acceleration moment upon the rotor. In order to achieve the advantageous synchronism, the generator moment can be set to match the current lift profile setting and the forces/moments resulting therefrom, such that the desired rotational speed is set, with the correct phase shift relative to the orbital flow. The generator moment can be influenced through, inter alia, influencing of an excitation current by the generator rotor (in the case of separately excited machines) and/or through controlling the commutation of a current converter connected in series after the stator.

From the forces at the individual coupling bodies, the vectorial superposition ultimately results in a rotor force that acts upon the housing of the rotor as a bearing force (also referred to as a reaction force) directed perpendicularly in relation to the rotor axis. This force changes its direction continuously, since the incident flow on the rotor and the position of the coupling bodies are also changing continuously. Averaged over time, in the case of a wanted or unwanted asymmetry of the bearing force over time, an effective force is obtained that likewise acts perpendicularly in relation to the rotor axis and that, in the form of a translational force or, in the case of a plurality of rotors, as a combination of translational forces, can influence a position of a corresponding wave energy converter and be used selectively for influencing position. With a corresponding design of the coupling bodies, e.g. with their longitudinal axes disposed obliquely, it is also possible to generate a bearing force directed perpendicularly in relation to the rotor axis, as explained more fully elsewhere in the document.

Since the rotor is preferably realized as a system floating under the surface of a body of water that has waves, the explained rotor force acts as a displacing force upon the rotor as a whole, and must be supported accordingly, if the position of the rotor is not to alter. As mentioned, this is achieved, for example, in US 2010/0150716 A1 through the provision of a plurality of rotors, whose forces counteract each other. In this case, the displacements compensate each other over a revolution, if constant incident flow conditions at the coupling bodies, and the same settings of the angle of attack γ, and thus of the first torque, and a constant second torque are assumed.

Thus, by means of an appropriate change in the rotor force, by influencing the first and/or second torque, while maintaining the synchronism, it is also possible to achieve a situation in which the rotor forces do not compensate each other per revolution, such that, for example, it is possible to achieve a displacement of the rotor perpendicular to its rotation axis.

If a rotor has a plurality of coupling bodies, it can be provided that each coupling body has its own adjustment device, such that the coupling bodies can be set independently of each other. Advantageously, the coupling bodies are set to the locally prevailing flow conditions in each case. This enables depth effects and width effects to be compensated. In the case of the previously explained “synchronous” operation, the generator moment in this case is tuned to the rotor moment generated by the sum of the coupling bodies.

A control device is provided for the purpose of controlling the wave energy converter. As control variables, the control device uses the adjustable second torque of the at least one rotor and/or the adjustable first torque, e.g. through the adjustment of the at least one coupling body. In addition to the machine state variables, with acquisition of the rotor angle and/or coupling-body adjustment, it is also possible to use the currently prevailing local flow field of the wave. This can be determined by means of corresponding sensors. In this case, these sensors can be disposed so as to rotate concomitantly on parts of the rotor and/or on the housing and/or independently of the machine, preferably positioned in front of the latter. Local, regional and global acquisition of a flow field, wave propagation direction, orbital flow and the like can be provided, wherein “local” acquisition may relate to the conditions existing directly at a component of a wave energy converter, “regional” acquisition may relate to acquisition on component groups or a discrete machine, and “global” acquisition may relate to the system as a whole or to a corresponding converter park. This makes it possible to perform predictive measurement and forecasting of wave states. Measured variables may be, for example, the flow velocity and/or flow direction and/or wave height and/or wave length and/or period and/or wave propagation velocity and/or machine motion and/or holding moments of the coupling body adjustment and/or adjustment moments of the coupling bodies and/or the rotor moment and/or forces transmitted into a mooring.

Preferably, the currently existing incident flow conditions at the coupling body can be determined from the measured variables, such that the coupling body and/or the second torque can be set accordingly, in order to achieve the higher-level feedback control objectives.

Particularly preferably, however, it is provided that the entire propagating flow field is known from appropriate measurements upstream from the machine or a park of a plurality of machines. Through appropriate calculations, therefore, it is possible to determine the subsequent local incident flow against the machine, thereby enabling the machine to be controlled in a particularly accurate manner. By means of such measurements it would be possible, in particular, to implement a higher-order machine control that, for example, aligns itself to a main component of the incoming wave. It is thereby possible to achieve particularly robust operation of the machine.

All rotors rotate relative to one or more interconnected housings. These housings may be interconnected in a largely rigid manner or in an adjustable manner. The interconnection of all housings is referred to as a frame. Preferably, the distance between rotors (for example, the distance in the y direction between the sub-machines 1a and 1b in FIG. 5) can be altered by means of an adjustment device, or it is also possible to rotate the individual housing and rotors (rotational plane) in relation to each other. The positions and turnings of the sub-machines in relation to each other are combined in a vector \vec{ρ}. The possibly available adjustment parameters of all coupling bodies are combined in the vector \vec{γ}. In this case, a coupling body may have no degree of freedom (and therefore no associated adjustment parameter), or just one degree of freedom or, also, several degrees of freedom (e.g. change in an angle of attack and rotation of the foil profile used, alteration of flap positions, shape changes, etc.).

The braking moment between the rotor i and the housing i is denoted by Mᵢ, and all considered braking moments are combined in the vector \vec{M}. It is preferably provided in this case that the housing is the stator of a directly driven generator, and the rotor base is the generator rotor of a directly driven generator. Alternatively, however, other drive train variants are also conceivable, which drive trains, in addition to or instead of having a generator, have a transmission and/or hydraulic components such as, for example, pumps. The braking moment may be exclusively positive, or positive and negative. The braking moment may be realized additionally or, also, exclusively by an appropriate brake. Moreover, the braking moments may be realized differently for the different rotors. The rotational angle and angular velocity of the rotor i are denoted by ψᵢ and ωᵢ, respectively, and the corresponding quantities for all rotors are combined in the vectors \vec{ψ} and \vec{ω}. The position of a fixed point (for example center of mass) of the frame is denoted by (x,y,z), and the turning of the frame about fixed axes through this point is denoted by (Θₓ, Θ_{y}, Θ_{z}) (combined in the vector \vec{θ}).

The invention includes a selective specification of the braking moment \vec{M}. In a preferred embodiment, the invention also includes a selective specification of the adjustment parameters \vec{γ} of the coupling bodies and/or of the hydrostatic lift forces \vec{F}_{B} and/or of the frame geometry \vec{p} and/or of the thrust of one or more auxiliary drives. For the purpose of implementing the invention, expediently, there is a computing unit set up with corresponding programming. With regard to further details, reference may be made to FIG. 4 and the associated description.

The vectors \vec{γ}, \vec{M}, \vec{F}_{B}, \vec{p} may include no element (if there is no setting device for this quantity), or just one element or, also, any number of elements, depending on the total number of available adjustment devices and degrees of freedom of the adjustable braking moments, coupling bodies and adjustable lift forces. The aim of specifying these quantities comprises at least one element from the group comprising: maximizing the energy produced by the machine over a certain interval of time, ensuring an output (generation of electricity) that is as constant as possible, stabilization of the position \vec{r} of the frame in space, stabilization of the turning \vec{θ} of the frame, selective displacement of the machine, selective rotation of the machine, selective excitation of vibrations, and start-up of the machine.

The invention enables the machine to be operated in a particularly economic manner, since appropriate conditions for energy generation are always ensured. In the case of certain, non-ideal flow conditions (e.g. relatively rapid change in the flow conditions within a few minutes), it is only by means of the invention that the conversion of wave energy into a useful form of energy even becomes possible at all. The invention also makes it possible to stabilize the rotor axis in space and to stabilize or selectively alter the immersion depth and the associated mooring forces. As a result, the anchorage of the machine, and any auxiliary drives, can be of a small, inexpensive design.

Further advantages and developments of the invention are given by the description and the accompanying drawing.

It is understood that the above-mentioned features and those yet to be explained in the following can be applied, not only in the respectively specified combination, but also in other combinations or singly, without departure from the scope of the present invention.

The invention is represented schematically in the drawing, on the basis of exemplary embodiments, and is described in detail in the following with reference to the drawing.

### DESCRIPTION OF THE FIGURES

FIG. 1 shows a perspective view of a preferred embodiment of a wave energy converter according to the invention.

FIG. 2 shows a side view of the wave energy converter according to FIG. 1, and illustrates the angle of attack γ and the phase angle Δ between a rotor and an orbital flow.

FIG. 3 shows resultant incident flow angles a₁ and a₂, and resultant forces at the coupling bodies of the rotor from FIG. 2.

FIG. 4 shows a perspective view of a further preferred embodiment of a wave energy converter according to the invention.

FIG. 5 shows a perspective view of a machine composed of three wave energy converters according to FIG. 1.

FIG. 6 shows a general control diagram for controlling a wave energy converter.

FIG. 7 shows a first control diagram for adjusting a braking moment according to a preferred embodiment of the invention.

FIG. 8 shows a second control diagram for adjusting a braking moment, with separate precontrol and feedback control, according to a preferred embodiment of the invention.

FIG. 9 shows a control diagram for adjusting a braking moment and coupling bodies, according to a preferred embodiment of the invention.

FIG. 10 shows a control diagram of a combined energy conversion control and position control, for adjusting a braking moment, coupling bodies and a lift force, according to a preferred embodiment of the invention.

FIG. 11 shows a block diagram of the position control according to FIG. 10.

FIG. 12 shows a block diagram of the energy conversion control according to FIG. 10.

FIG. 13 shows a model of the coupling bodies for the energy conversion control according to FIG. 12.

FIG. 14 shows a variant of the position control according to FIG. 11.

FIG. 15 shows a further variant of the position control according to FIG. 11.

In the figures, elements that are the same or have the same function are denoted by identical references. For reasons of clarity, explanations are not repeated.

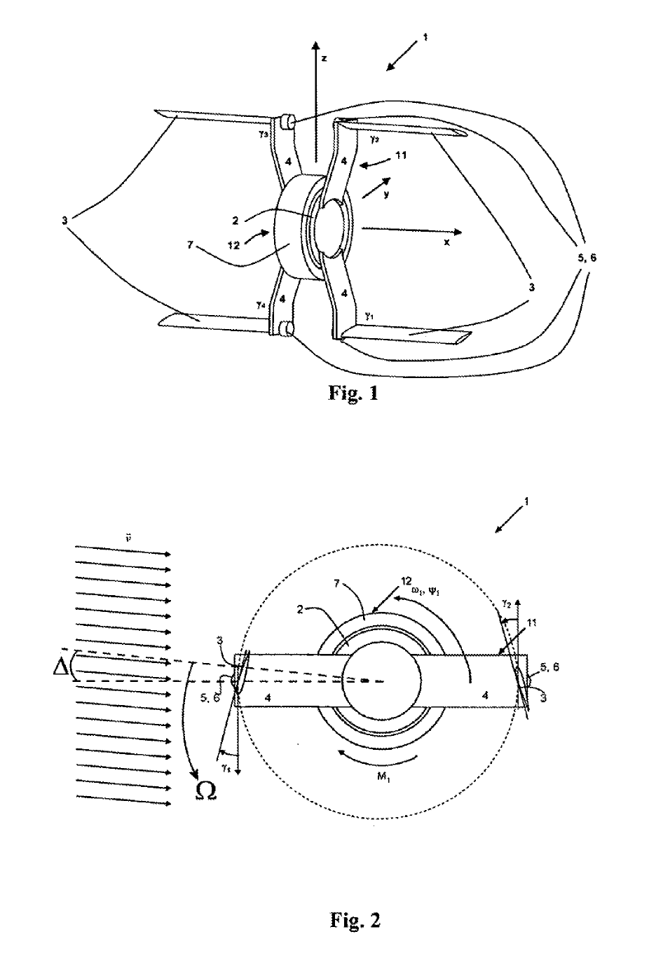

The invention presented relates to the operation of rotating machines for the purpose of obtaining energy from moving fluids, for example the sea. The principle of functioning of such machines is first explained in the following with reference to FIGS. 1 to 4.

FIG. 1 shows a wave energy converter 1 having a rotor base 2, a housing 7 and four coupling bodies 3 that are each respectively fastened to the rotor base 2 in a rotationally fixed manner via lever arms 4. The wave energy converter 1 is intended for operation beneath the water surface of a body of water having waves—for example, an ocean. In the example shown, the coupling bodies 3 are realized as lift profiles. The components 2, 3, 4 are constituent parts of a rotor 11. The position of the housing 7 is described by the position \vec{r}=(x,y,z) of the center of mass of the housing and by the turning \vec{θ}=(Θₓ,Θ_{y},Θ_{z}) of the housing about the x, y and z axes. The housing 7 is a constituent part of a frame 12. The rotor 11 is mounted so as to be rotatable relative to the frame 12. It must be pointed out that, in the representation shown, in particular, all lever arms 4 are fastened in a rotationally fixed manner to one and the same rotor base 2. The frame 12 is connected in a rotationally fixed manner to the stator of a directly driven generator, and the rotor 11 (here, the rotor base 2) is connected in a rotationally fixed manner to the generator rotor of a directly driven generator.

The coupling bodies 3 are realized as lift devices and disposed at an angle of 180° in relation to each other. Preferably, the lift devices are mounted close to their pressure point, in order to reduce rotation moments upon the lift devices that occur during operation, and thereby to reduce the demands on the support and/or on the adjustment devices.

Expediently, an adjustment device 5, having at least one degree of freedom, is available for each of the coupling bodies 3 (usually also as a constituent part of the rotor), for the purpose of altering the position (e.g. “pitch angle”) of the respective coupling body and thereby influencing the interaction between the fluid and the coupling bodies. The degree of freedom of the adjustment devices is described here by adjustment parameters γ₁ to γ₄. The adjustment devices are preferably electric motor type adjustment devices. Preferably, there is also a sensor system 6 available for sensing the current adjustment.

FIG. 2 shows a side view of the machine with the lever arms turned round by 90°. In the present example, the adjustment parameters γ₁ and γ₂ (as also the adjustment parameters γ₃ and γ₄) denote the angles of attack of the coupling bodies 3 in relation to the tangent (represented by an arrow) of the circular path through the suspension point (rotation point) of the coupling bodies.

The wave energy converter 1 is surrounded by a flow vector field \vec{ν}. In the case of the embodiments described, it is assumed that the incident flow and the orbital flow are the flow of sea waves, the direction of which changes continuously. In the case represented, the rotation of the orbital flow is oriented anti-clockwise, and so the associated wave propagates from right to left. In the monochromatic case, the incident flow direction in this case changes at the angular velocity O=2pf=const., wherein f represents the frequency of the monochromatic wave. In multichromatic waves, by contrast, O is subject to a time change, O=f(t), since the frequency f is a function of time, f=f(t). The incident flow causes forces to be produced at the coupling bodies. As a result of this, the angle ψ₁ of the rotor base 2 changes relative to the horizontal at an angular velocity ω₁=\dot{ψ}₁ (\dot{ψ}₁ denotes the derivative of the time-dependent quantity ψ₁ for time). It is provided that the rotor 2,3,4 rotates in synchronism with the orbital flow of the wave motion at ω₁, wherein the term synchronism is to be understood in the manner previously explained. In this case, for example, O≈ω₁. A value, or a value range, for an angular velocity ω₁ of the rotor on the basis of an angular velocity O of the orbital flow is specified, and adapted to the latter. In this case, a constant control or a short-time, or short-term, adaptation may be effected.

At the rotor 11, a variable braking moment M₁ acts between the rotor base 2 and the housing 7, or frame 12. The braking moment can act in a positive direction (contrary to the angular velocity ω₁), but also in a negative direction (i.e. driving).

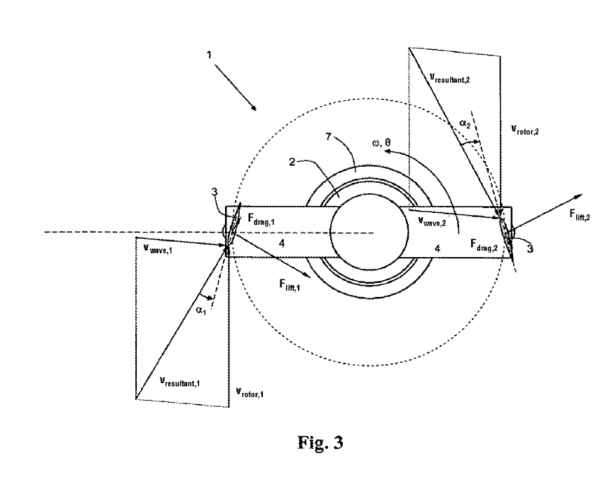

Between the rotor orientation, which is indicated by a lower broken line running through the rotor axis and the center of the two adjustment devices 5, and the direction of the orbital flow, which is indicated by the upper broken line running through one of the velocity arrows \vec{ν}, there is a phase angle Δ, the magnitude of which can be influenced by the setting of the first and/or second torque. A phase angle of −45° to 45°, preferably of −25° to 25°, and particularly preferably of −15° to 15°, appears in this case to be particularly advantageous for generating the first torque, since in this case the orbital flow v_{wave} and the incident flow are oriented largely perpendicularly in relation to each other, owing to the spin vᵣₒₜₒᵣ (see FIG. 3), causing the rotor moment to be maximized. Maintaining the required synchronism, Δ≈const., wherein—as already described above—a swing around a mean value of Δ is also understood to be synchronous within the scope of the invention. In FIG. 2 and the subsequent figures, the coupling bodies are represented in a merely exemplary manner for the purpose of defining the various machine parameters. In operation, the angles of attack of the two coupling bodies are preferably realized in a manner opposite to that represented. The coupling body on the left in FIG. 2 would then be adjusted inward, and the coupling body on the right in FIG. 2 would be adjusted outward.

FIG. 3 shows the resultant incident flow conditions and the forces ensuing at the coupling bodies that produce a rotor torque. It is assumed in this simplified case that the flow is uniform in nature, and is of the same magnitude and the same direction, over the entire rotor cross section. However, particularly for rotors of large radial extent, it may be the case that the various coupling bodies 3 of the rotor 11 are located at differing positions relative to the wave, resulting in a locally different incident flow direction. This can be compensated, however, for example by means of an individual setting of the respective angle of attack γ.

FIG. 3 shows the local incident flows at the two coupling bodies caused by the orbital flow (v_{wave,i}) and by the spin (v_{rotor,i}), the incident flow velocity (v_{resultant,i}) that results as a vector sum from these two incident flows, and the ensuing incident flow angles a₁ and a₂. Also derived are the ensuing lift and drag forces F_{lift,i} and F_{drag,i} at both coupling bodies, which are dependent both on the magnitude of the incident flow velocity and on the incident flow angles a₁ and a₂, and therefore also on the angles of attack γ₁ and γ₂, and which are oriented perpendicularly and parallel, respectively, to the direction of v_{resultant,i}.

For the case represented, the two lift forces F_{lift,i} result in an anticlockwise rotor torque, and the two drag forces F_{drag,i} result in a rotor torque of lesser magnitude in the opposite direction (i.e. in the clockwise direction). The sum of the two rotor torques produces a rotation of the rotor 11, the velocity of which can be set through the reaction torque, by means of the adjustable second torque.

If the synchronism required according to the invention is achieved with Δ≈const., then it is immediately evident from FIG. 3 that, for monochromatic cases, in which the value of the flow v_{wave,i} and the angular velocity O remain constant, the incident flow conditions of the two coupling bodies 3 do not alter over the rotation of the rotor. This means that, with constant angles of attack γ, a constant rotor moment is generated that can be picked up with a constant second torque of a corresponding generator.

From the forces acting on the coupling bodies, in addition to a rotor moment, a resultant rotor force is also obtained as a result of vectorial addition of F_{lift,i}, F_{drag,i}, F_{lift,2} and F_{drag,2}. This rotor force acts as a bearing force upon the housing, and must be supported accordingly if displacement of the housing is not wanted. While the rotor moment remains constant, assuming the same incident flow conditions (v_{wave,i}, Δ, O, ω, a₁, a₂, γ₁, γ₂=const.), this applies only to the magnitude of the resultant rotor force. Owing to the continuously changing flow direction of the orbital flow and the synchronous rotor rotation, the direction of the rotor force changes accordingly.

As well as influencing the rotor moment by adjustment of the angle of attack γ and/or adjustment of the phase angle Δ, it is also possible to influence the magnitude of this rotor force by changing the angle of attack γ (as a result of which the incident flow angles a change), by changing the rotor angular velocity ω and/or the phase angle Δ—for example, by changing the generator moment applied as the second moment (as a result of which v_{rotor,i} changes) and/or by a combination of these changes. Preferably, in this case, the synchronism described in the introduction is maintained.

Through appropriate adjustment of these control variables per revolution, and an associated alteration of the rotor force, the wave energy converter can be moved in any radial direction. It is to be noted in this connection that the representation in FIG. 3 includes only an orbital flow that is directed perpendicularly in relation to the rotation axis and that does not have any flow components in the direction of the plane of the drawing. If, contrary to this, as is the case under real conditions, the rotor receives an oblique incident flow, the result is a rotor force that, in addition to having a force component directed perpendicularly in relation to the rotor axis, also has an axial force component. The latter is due to the fact that the hydrodynamic drag force of a coupling body is directed in the direction of the local incident flow.

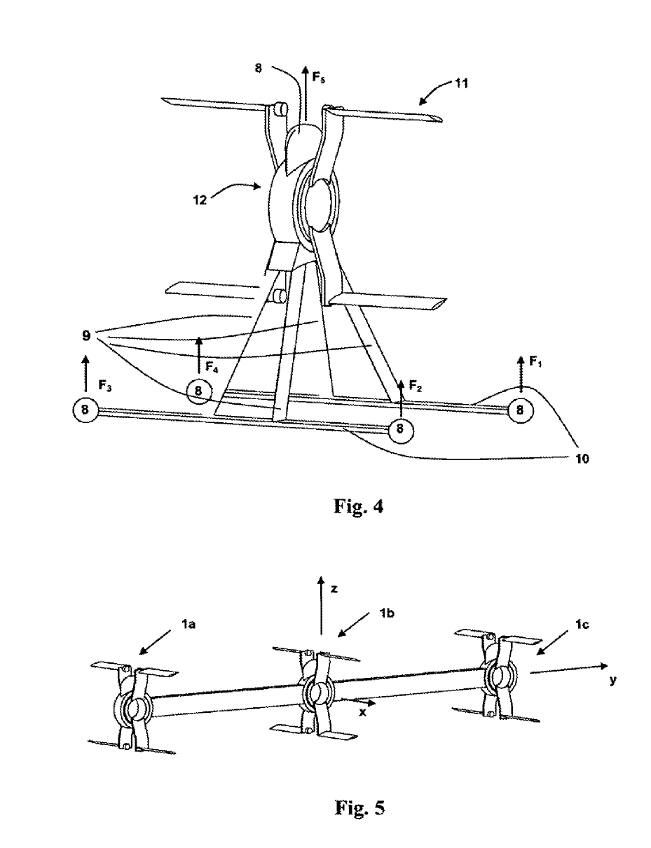

Represented in FIG. 4 is a further preferred embodiment that, as compared with FIGS. 1, 2 and 3, provides additional damping plates 10, for the purpose of position stabilization, which are connected to the housing 7 of the machine in a largely rigid manner, via supports 9. Additionally provided is a lift system 8, which consists of tanks that can be filled with fluid or, also, emptied. This enables the lift forces F₁, F₂, . . . (combined in the vector \vec{F}_{B}) acting at the lift bodies 8 to be altered. The lift forces can be altered by pumping fluid over between the tanks, or between tanks and the area around the machine. The lift system 8 may also have positionable weights, in order to alter the point of application of a weight and to bring about an effect similar to that of changing the lift forces. The lift system 8, supports 9 and damping plates 10 are constituent parts of the frame 12.

Alternatively or additionally, a mooring, not represented in the figures, may be provided.

FIG. 5 shows an alternative embodiment of an advantageous wave energy converter having a largely horizontal frame extent and a plurality of sub-machines 1a, 1b, 1c.

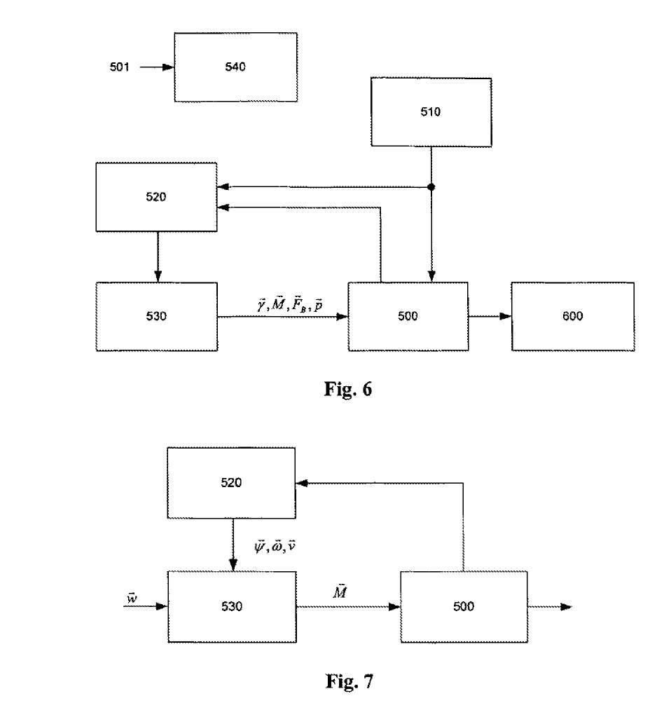

A preferred basic structure of a wave energy converter according to the invention is represented in a block diagram in FIG. 6. The wave energy converter has a machine 500 that acts as a controlled system (for example, having a housing, rotor, energy converter, lift system, etc.). The machine 500 serves primarily to generate electricity and to output this to an electricity grid 600.

Acting upon the machine 500 are ambient conditions 510 (flows, mooring forces, weights, lift forces, etc.). These conditions are acquired, at least partially, and supplied to a block 520 for measurement and signal processing. Also supplied to the block 520 are machine quantities (e.g. actual position \vec{ψ} of the rotor, \vec{r},\vec{θ} of the frame, actual position \vec{γ} of the coupling bodies).

The block 520 measures and, if necessary, processes the received quantities, and outputs results to a control unit 530. The latter, in dependence on the supplied results, determines one or more control variables (specified values \vec{γ},\vec{M},\vec{F}_{B},\vec{p}), and applies these to the machine 500. In addition, lower-order open-loop or closed-loop control loops may be provided in the machine, as described at a later point.

By means of various sensors, the positions (in particular, adjustment parameters such as pitch angle) of the coupling bodies, the forces \vec{F}_{coupl} between the individual coupling bodies and the frame, the position (x,y,z) and turning (θₓ,θ_{y},θ_{z}) of the frame are measured. These quantities can be filtered and then forwarded directly to the individual controllers.

To obtain information about the flow vector field surrounding the machine, there are two possible approaches.

The first approach relates to the situation in which there are measurement data available relating to the fluid (e.g. flow vectors, surface data, pressure measurements, etc.), but these measurement data are insufficient for controlling the machine. For example, surface elevations could be measured but, in order to control the machine, it is important to know the direction of the flow vector at the machine. In this case, the direction of the flow vector at the machine is calculated by means of a model of the fluid. In a simple case, a mathematical function is available, which directly calculates the direction of the flow vector from current surface data. In general, however, it is also possible to use dynamic models given by differential equations, which are calculated by a numerical integration method. These models are used to calculate missing measurement information. The available measurement data are used for continuous correction of the models used.

The second approach may be used to improve the first approach or, also, for the case in which there are no measurement data available relating to the fluid. In this case, measurement data from the machine (immersion depth, acceleration, tilt, etc.) are used to obtain information about the flow conditions around the machine. This is achieved by using a model of the interaction between the machine and the surrounding flow vector field. This model and the measurement data from the machine can then be used to calculate information about the flow vector field. Obviously, if measurement data relating to the fluid are additionally available, these data enhance the information about the flow vector field.

Knowledge of the flow vector field is helpful in creating specified values, e.g. in order to calculate a specified value for the immersion depth of the machine. Based on flow data, it is helpful to estimate the main wave direction, in order to create a specified value for the orientation θ_{z} of the machine. Flow information is also helpful for appropriate pitching and appropriate moment control.

For each measurable adjustment parameter γᵢ (denotes a component of the vector \vec{γ}) it is possible to provide, in the course of a lower-order control, a standard control loop (e.g. PI controller with anti-windup), in which, through the variation of a control variable (e.g. current through an electric motor, volumetric flow of a hydraulic device), the measured controlled variable γᵢ can be adjusted according to the specification from the block 530. A control that operates entirely without feedback of measurement values, or on the basis of the measurement of other quantities, is provided for each non-measured adjustment parameter.

For each measurable and adjustable braking moment Mᵢ, it is likewise possible to provide a lower-order control loop in which, through the variation of a control variable (e.g. rotor current, stator current, connection diagram of a current inverter connected after the generator), the moment \vec{M}ᵢ can be adjusted according to the specification from the block 530. A control that operates entirely without feedback of measurement values, or on the basis of the measurement of other quantities, is provided for each non-measured moment.

For each measurable and adjustable frame parameter pᵢ, it is likewise possible to provide a lower-order control loop in which, through the variation of a control variable (e.g. fluid flow through a hydraulic valve), the frame parameter pᵢ can be adjusted according to the specification from the block 530. A control that operates entirely without feedback of measurement values, or on the basis of the measurement of other quantities, is provided for each non-measured frame parameter.

Simple controls may also be provided for the filling of the lift bodies. In addition, simple controls may be provided for any auxiliary drives.

An advantageous effect of the lower-order controls is that the quantities \vec{γ}, \vec{M}, \vec{F}_{B}, \vec{p} are directly available as virtual control variables.

A higher-order coordinator 540 may be provided, which coordinates the machine in dependence on a user requirement 501, e.g. an operating mode. The coordinator preferably communicates with all control systems, and has information relating to grid utilization and/or takes account of user requirements. For example, there may be provision for switching over between the operating modes “energy generation”, “position change”, “servicing mode”, “safety mode” (submerging the machine during storms), “idle mode” (feed-in of current into the grid not possible or not wanted), “test operation” (for putting into operation or fault-finding). Other operating modes besides these may also be provided.

The representations in FIGS. 7 to 9 are based on the representation according to FIG. 6. In the figures, elements that are the same are denoted by the same references. To aid comprehension, the figures are based on a machine having a rotor, in which only one adjustable braking moment M, as a second torque, an angle ψ and/or an angular velocity ω need be considered. This may easily be generalized for the case of a plurality of rotors, in that the calculations specified below are performed separately for each component \vec{M}, \vec{ψ}, \vec{ω}. The angles \vec{ψ} and/or the angular velocities \vec{ω} and/or properties of the flow vector field \vec{ν} are measured in or at the machine 500. A measurement quantity can also be calculated by means of processing the signal from another quantity, through integration, differentiation or by means of a filter, which may include a model of the machine. The vector-valued quantity \vec{ω} denotes variable inputs of the control such as, for example, specified values or adjustable parameters.

Represented in FIG. 7 is a first preferred embodiment of the invention as a control diagram. Only the braking moment \vec{M} is used as a control variable. The diagram according to FIG. 8 corresponds to that according to FIG. 7, but with the block 530 having been divided into a control block 531 with feedback (“feedback control block”) and a control block 532 without feedback (“precontrol block”).

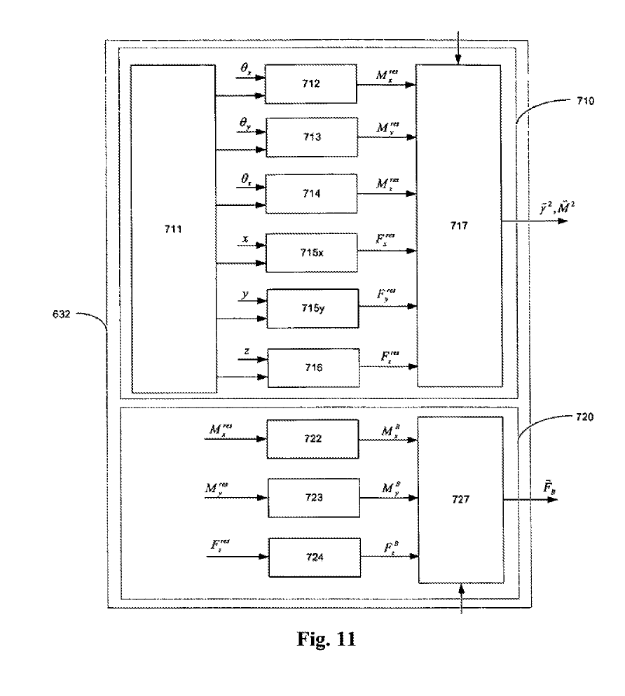

FIG. 8 is a special realization of a particularly advantageous general, two-stage control concept, based on the example of controlling only the second torque. However, the concept per se is suitable for controlling all quantities. The first part represents a so-called model-based precontrol. In this case, the knowledge of the mathematical model of the machine (cf. also description relating to FIGS. 11 to 15) is utilized in such a manner that the second torque to be specified is calculated by using the knowledge of status data (in particular, of the excitation, i.e. of the wave, in the form of the incident flow angle and the magnitude of the incident flow velocity). In this case, in particular, status data that go beyond the instantaneous point in time may also be included. This is important, in particular, in multichromatic waves, since “passing through” lesser harmonics may also be appropriate here to some extent. The status data may be acquired by sensors in various ways, as described in this application. This enables the incident flow conditions at the site of the machine to be considered in advance. From the data, by using the potential theory, and therefore with knowledge of the current and future flow conditions around the machine, and particularly around the coupling body/coupling bodies, it is possible to calculate a desired machine behavior, and consequently the second torque to be specified.

The second part of the control concept then consists in correcting the deviations of the system from the optimum trajectories calculated jointly with the precontrol. This may consist, in one embodiment of the control, in regulating the second torque (generator moment) and the first torque (e.g. via the adjustment parameters of the coupling bodies) in such a manner that a desired objective is attained, such as, for example, maximization of the absorbed power, high degree of steadiness of the absorbed power, maximization of the service life of the load, overload protection and limitation of the absorbed power (survival in storms), combinations of power profiles specified by a consumer.

In summary, in a first stage a control variable is determined in the control block 532, on the basis of status data. In the second stage, the deviations of the system from the determined specified behavior are adjusted by the block 531. Such a two-stage concept approach makes it possible to achieve a machine behavior that optimizes the synchronism and energy yield aspects of rotating machines. This two-stage concept is not limited to rotating machines but may also be applied to other systems such as, for example, “point absorbers” or similar.

A variant that may be implemented particularly easily is given by FIG. 8, with omission of the block 531. In a pure precontrol, a constant braking moment M₀

M=M₀ (1)

is specified, such that, in stationary mode, a rotational speed ω_{stationary} (M₀)>0 ensues. The power generated by the machine in stationary mode is then P=Mω_{stationary}(M₀)>0, i.e. the machine generates energy at each instant. M₀ may be set independently of the current sea state, for example increasing with increasing wave height.

A disadvantage of this variant is that, in the case of a large selected value of M₀ and a short-term change in the sea state, the large braking moment results in a reduction of ω. In the case of certain machine configurations, this reduction in the angular velocity can result in separation of the flow at the coupling bodies, and the machine comes to a standstill or, more generally, the synchronism is lost. A remedy for this was provided by the variant of the control in FIG. 7, with the control law

M=k(ω−w), (2)

the braking moment depends on a constant controller parameter k>0 (moment acts as a braking moment contrary to the direction of rotation of the rotor, cf. FIG. 2) and the difference of the rotational speed ω from a specified value w<ω_{stationary}. The quantity ω_{stationary} in this case denotes the machine rotational speed that ensues without a braking moment (or in the case of only a small braking moment) in stationary mode. If, under the control law (2), there is a retardation of the machine as a result of short-term flow changes, then the braking moment M drops automatically, and the machine speeds up again. Because of this control law, a significantly more stable rotary motion of the machine is achieved. Nevertheless, it is only necessary to measure the machine rotational speed. The machine rotational speed can also be calculated on the basis of other measurement quantities. A further advantage of this control law (2) is that starting-up of the machine from a standstill is supported: provided that the machine rotational speed ω is less than w, a driving moment acts upon the rotor. Under this condition, the machine consumes energy, and it is only when ω is greater than w that operation with energy generation commences.

The control law (2) can be further improved by expanding it by an angle-dependent function ƒₚ(Ψ), such that the control law

M=k(ω−w₁)+ƒₚ(Ψ) (3)

is obtained as a result. The function ƒₚ(Ψ) is periodic, wherein, in particular, 2π- or π-periodic functions (equivalent to 360° and 180° periodic, respectively) are expedient for the type of machine described here. By expanding the control law (2) by the function ƒₚ(Ψ), it is possible to the take into account that, depending on the rotation angle of the machine, a different braking moment is suitable for obtaining a maximum energy yield. Further improvements of the control law (3) are possible in that, in order to maximize the power generation, improve the stability of the rotational motion or improve the start-up behavior, non-linear laws of the form

M=ƒₙₒₙₗᵢₙ¹(ω,w₁)+ƒₚ(Ψ) (4)

or, yet more generally, M=ƒₙₒₙₗᵢₙ²(ω,w₁,Ψ) are used. Likewise, it is conceivable for the controller to be of a dynamic design, such that the control law is given, not only by an algebraic equation of the form (1), (2), (3), etc., but also, in addition, by a differential equation.

A different form of control law may be used if there is information available relating to the flow vector field around the machine and/or relating to the fluid surface at and around the machine position. In this case, a specified value w_{angle} may be calculated for the rotation angle Ψ, in which the alignment of the machine relative to the flow vector field produces a maximum propulsive moment. The control deviation w_{angle}−Ψ is then applied to a suitable control algorithm, and the latter alters the braking moment such that the control deviation disappears (simple possibility: PI controller; improved possibility: cascade control of PI controller for the rotational speed and P controller for the rotational angle) or always moves within a small range (simple possibility P controller). This ensures that the rotor is predominantly in synchronism with the surrounding flow field.

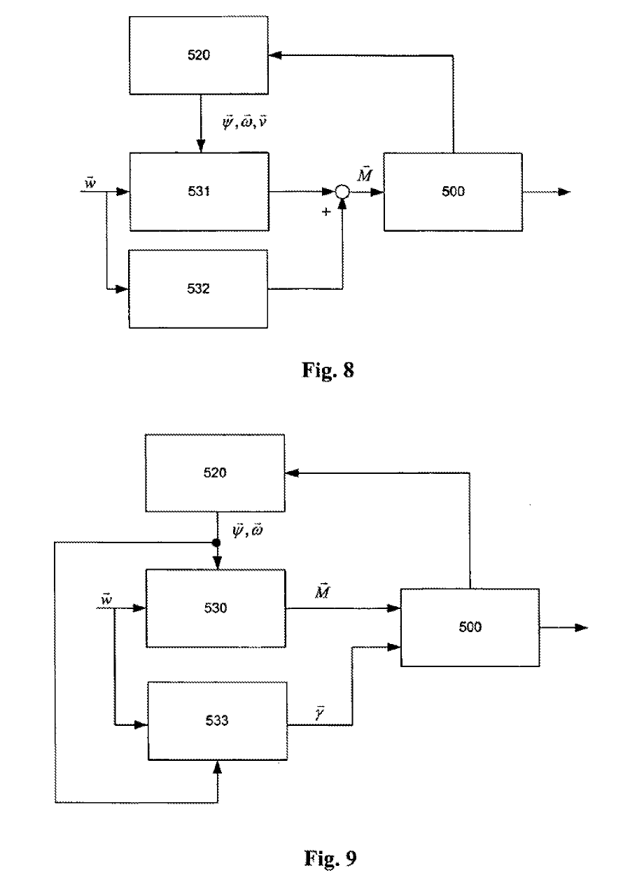

FIG. 9 shows an expansion of the embodiments according to FIG. 7 or 8, for the case of additionally adjustable coupling bodies. The example provides a precontrol 533 for the coupling bodies that, in dependence on \vec{w} and the quantities \vec{ψ}, \vec{ω}, outputs values, as control variables, for the degrees of freedom \vec{γ} of the coupling bodies. This is preferably effected on the basis of a model of the machine, which model is used to set \vec{γ} such that the power as a sum of all integrals

$${\int }_{t 0}^{t 1} {P}_{i} ( τ ) d τ = {\int }_{t 0}^{t 1} {M}_{i} ( τ ) {ω}_{i} ( τ ) d τ \qquad ( 5 )$$

is maximum over the period from t₀ to t₁. The special case t₀->t₁ includes the embodiment whereby the power is maximum at each instant. In principle, the degrees of freedom of the coupling bodies and/or the braking moment are to be set such that the rotor is predominantly in synchronism with the flow vector field.

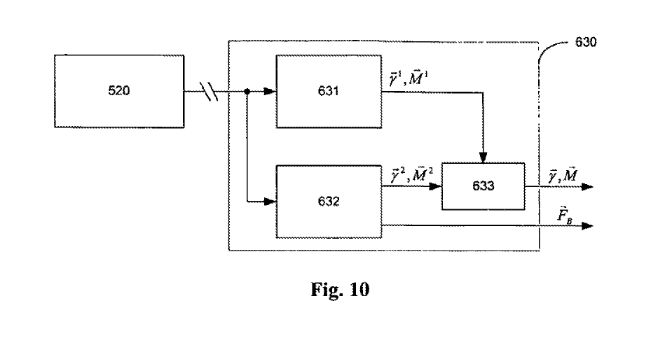

Implemented as a further development of the invention is a combination of energy conversion control and position control, as described in the following with reference to FIG. 10. FIG. 10 in this case shows, in a block diagram, a modified control block 630, which comprises a block 631 for power control, a block 632 for position control, and a block 633 for bringing together control variables.

The control variables \vec{γ}¹, \vec{M}¹ and \vec{γ}², \vec{M}² generated by the two control blocks 631 and 632, respectively, are weighted in the block 633 and converted into the virtual control variables \vec{γ}, \vec{M}. Weighting of the control variables is particularly advantageous, since the two sub-controls 631 and 632 may work against each other in certain situations. For example, a particularly stable position may deliver particularly little power, and vice versa. Then, without weighting, the entire control loop may become unstable.

It is obvious to combine the desired control variables of the position control and energy conversion control, weighted in dependence on the operating mode, to form the actual control variable. For example, in an operating mode “energy conversion”, it is mainly the control variable of the energy conversion control that is used, and only a very limited intervention of the position control is allowed, in order to avoid the machine moving away from its specified position and alignment. The weighting is performed adaptively, such that, if there is too great a change in the position of the machine, the position control is given a greater weight and, if there is too great a drop in the braking moment, the energy conversion control is given a greater weight. This weighting is advantageous because, during operation, situations repeatedly occur in which the position control will work against the energy conversion control (e.g. when the position control seeks to reduce the braking moment in order to counteract a change in the load angle, while the energy conversion control requires as great a braking moment as possible).

The block 632 for the position control also additionally generates the virtual control variable(s) \vec{F}_{B}.

A preferred design for the block 632 for the position control is represented in FIG. 11. The position control shown in FIG. 11 comprises two essential parts, namely, a part 710 for the virtual control variables \vec{γ}², \vec{M}² that act rapidly upon the position, and a part 720 for the forces \vec{F}_{B} by lift bodies, which can be altered rather more slowly. The part 710 comprises a block 711 for reference value generation and, if appropriate, trajectory planning, a block 712 for controlling a load angle, a block 713 for controlling a tilt angle, a block 714 for controlling an orientation in relation to the wave direction, a block 715x for controlling an x position, a block 715y for controlling a y position, a block 716 for controlling an immersion depth, and a block 717 for control variable transformation.

The part 710 comprises a block 722 for controlling a load moment, a block 723 for controlling a tilting moment, a block 724 for controlling a lift force, and a block 727 for control variable transformation.

The principle of the rapid part 710 of the position control is that, through selective adjustment of the coupling bodies 3 and braking moments \vec{M}, forces in the x, y and z directions, and moments about all axes, can be exerted upon the frame 12. With knowledge of the current flow conditions, setting parameters and velocities of the coupling bodies, the current coupling body parameters and braking moments can be converted into resultant moments Mₓ^{res}, M_{y}^{res}, M_{z}^{res} and resultant forces Fₓ^{res}, F_{y}^{res}, F_{z}^{res}. The solving of these equations for the coupling body parameters and braking moments results in the control variable transformation represented in FIG. 11. Should the equations be over-determined or under-determined, an optimization is performed, in dependence on the current operating mode, in order to calculate the coupling body parameters, adjustment parameters of the coupling bodies and braking moments that are the best possible in the current situation. If the equations are over-determined, for example, the resultant degrees of freedom can be used in the safety mode, in order to alter the immersion depth of the machine (movement in the z direction) as rapidly as possible.

On the basis of the control variable transformation, five single-variable controllers are drawn up, having the virtual control variables Mₓ^{res}, M_{y}^{res}, M_{z}^{res}, Fₓ^{res}, F_{y}^{res}, F_{z}^{res} and the controlled variables load angle θₓ, tilt angle θ_{y}, orientation θ_{z}, positions x and y, and immersion depth z. A model of the machine, based on system mechanics and flow mechanics, can be used for designing these controllers. In order to achieve high-quality control despite changes in the machine dynamics, e.g. as a result of bio-fouling, adaptive control algorithms may be used. Specified values for the controlled variables may be calculated on the basis of the current flow situation and a prediction of the future flow conditions. A trajectory plan converts these specified values into sequences of motions that can be executed by the machine. In the case of certain machine configurations, it is not possible to apply a force, e.g. directly in the x direction (rotation axis), by adjusting the coupling bodies and braking moments. In such cases, in particular, trajectory planning is important in order to specify specified values for the orientation controller (controlled variable θ_{z}) and the position controller (controlled variable here only y), such that a combination of rotations and translational motions results in an effective movement in the x direction.

The lower, slow part 720 of the position control takes account of the effect whereby the immersion depth z, the rotation of the frame 12 about the x axis (load angle) and the rotation of the frame about the y axis (tilt angle) can be altered in two different ways. On the one hand, as already described, the coupling bodies and braking moments may be adjusted. On the other hand, these quantities may also be influenced by altering the lift forces \vec{F}_{B}.

The control variable transformation 727 is based on the fact that the moments Mₓ^{B} and M_{y}^{B}, about the x and the y axis, respectively, of the frame 12, that result from the lift forces \vec{F}_{B}, and the resultant lift force F_{z}^{B} in the z direction, can be calculated by means of equations. Solving of these equations for the lift force \vec{F}_{B} results in the aforementioned control variable transformation.

The controls 722, 723, 724 for the load moment, tilting moment and immersion force have, as controlled variables, the quantities Mₓ^{res}, M_{y}^{res} and F_{z}^{res}, respectively, which are output, as control variables, by the controls for the load angle, tilt angle and immersion depth. The specified value of the controlled variables Mₓ^{res}, M_{y}^{res} and F_{z}^{res} is zero in each case, i.e. the objective of the lower three controls in FIG. 11 is to use the adjustment parameters of the coupling bodies and braking moments \vec{γ}², \vec{M}² as little as possible for the position control. There are thus as many degrees of freedom as possible for optimal energy conversion. Control variables for the lower controller are the moments Mₓ^{B}, M_{y}^{B} and the force F_{z}^{B}. If, for example, there is a jump in load, resulting in an unwanted change in the load angle θₓ, the control 712 for the load angle will react first and impress upon the machine a moment Mₓ^{res}, in order to counteract this change. In order to correct this moment Mₓ^{res} back to its specified value of zero, the control 722 for the load moment effects a change in the lift forces, such that an additional restoring moment upon the machine is generated. Owing to the turning of the machine as a result of this slowly increasing moment, the control 712 for the load angle slowly reduces its control variable until, ultimately, the moment necessary for compensating the load jump is applied entirely by the lift bodies.

For the design of the controllers 722, 723, 724 for the load moment, tilting moment and hydrostatic lift force, it is possible to use a model of the machine that is based on fundamental equations of system mechanics and that takes account of flow effects, added-mass effects and forces resulting from the mooring. Since, for the design of the these controllers, the dynamics of the adaptive load-angle, tilt-angle and immersion-depth controllers is of importance in addition to the machine dynamics, the controllers are expediently designed as adaptive controllers.

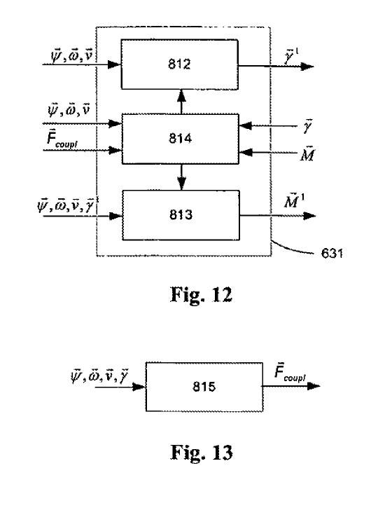

A preferred design for the block 631 for the control of the energy conversion is represented in FIG. 12. The block shown in FIG. 11 generates the control variables \vec{y}¹, \vec{M}¹, such that the machine generates the desired energy yield with the current frame position and the current flow conditions. The control consists of a component 812 for the adjustment parameters of the coupling bodies, a component 813 for the braking moments, and an adaptation component 814. These components are based on a model 815, shown in FIG. 13, of the forces \vec{F}_{coupl} upon the coupling bodies as a consequence of the position \vec{ψ}, the velocity \vec{ω} and the adjustment parameter of the coupling bodies \vec{γ}, as well as the flow conditions \vec{ν} around the machine.

The specification of the adjustment parameters of the coupling bodies uses this model, in order to define the adjustment parameters of the coupling bodies, for a given position \vec{ψ} and velocity \vec{ω}, such that the first torque is maximal. The adjustment parameters of the coupling bodies that result in a maximum first torque are output as \vec{γ}¹. The optimization problem to be solved for this is solved numerically or analytically.

The adaptation block 814 is used to continuously improve, during operation of the machine, the model 815 of the coupling bodies that is shown in FIG. 13. For this purpose, it is necessary to know all inputs and outputs of the model. The quantities \vec{ψ}, \vec{ω}, \vec{ν} are available from the measurement and signal processing operations. A value after the weighting block, or a measurement of the adjustment parameters of the coupling body from the lower-order control loops, is used as an adjustment parameter of the coupling bodies \vec{γ}. The forces \vec{F}_{coupl} are either measured directly, by means of force sensors, or indirectly, by means of moment sensors, acceleration sensors, or the braking moment acting at the rotor. By means of these signals, the model 815 of the coupling bodies from FIG. 13 can be verified in respect of its validity and, if necessary, adapted continuously.

The adaptation of the machine model in FIG. 13 can be further improved in that a wave form (e.g. periodic, sinusoidal) of small amplitude can additionally be superposed on the adjustment of the first and/or second torque (e.g. the motion of the adjustment parameters of the coupling bodies \vec{γ}). It can thus be ascertained whether a further change in, for example, the adjustment parameters of the coupling bodies still results in an increase in the forces \vec{F}_{coupl} and, if appropriate, an additional adaptation of the machine model or, also, an improvement of the solution of the optimization problem are effected, in order to determine the adjustment parameters of the coupling bodies.

The specification of the second torque is likewise based substantially on the model in FIG. 13. From this model, it is easy to calculate the first moment Mfluid, iM_{Fluid}¹, first moment upon the wave of the generator i. The angular velocity □ᵢωᵢ of this generator follows the differential equation

first moment Mfluid, i+M braking, I second moment

Jᵢ\dot{ω}ᵢ=M_{Fluid}ⁱ+M_{braking}ⁱ. (6)

This generated electrical energy in the period from t₀ to t₁ is

$${\int }_{t 0}^{t 1} {P}_{i} ( τ ) d τ = {\int }_{t 0}^{t 1} {M}_{braking}^{i} ( τ ) {ω}_{i} ( τ ) d τ . \qquad ( 7 )$$

The control variable M_{braking}ⁱ is then calculated from a maximization of the integral (7) over M_{braking}ⁱ, having regard to the lower-order condition (6). For this purpose, it is expedient to predict the flow vector field around the machine. The length of the time interval from t₀ to t₁ is a setting parameter. In the maximization of (7), the model that is adapted continuously in the course of pitch control is preferably used to determine the term M_{Fluid}ⁱ. A wave form (e.g. periodic, sinusoidal) of small amplitude can likewise be superposed on the change of M_{braking}ⁱ in order to improve the adaptation process of the model (cf. above).

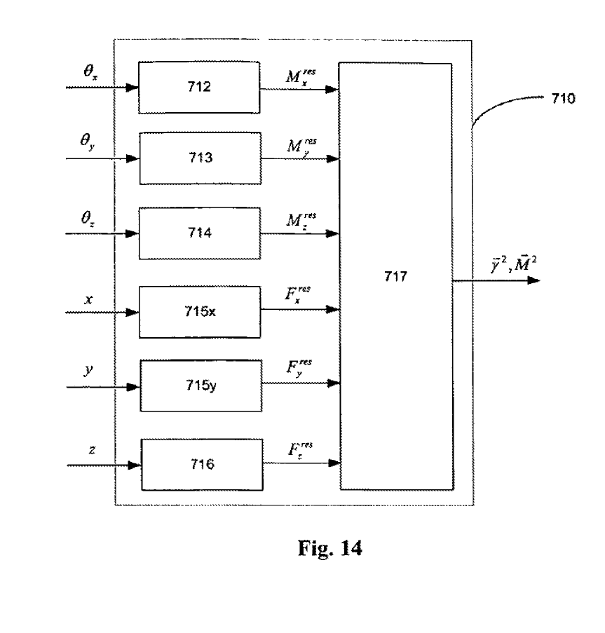

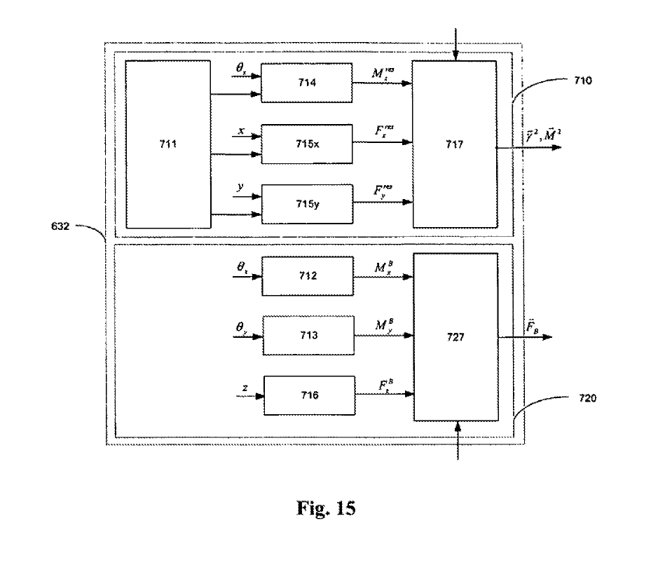

Two alternative embodiments of the position control according to FIG. 11 are represented in FIGS. 14 and 15.

A variant having simplified position control, without lift forces, is shown in FIG. 14. Here, the load angle, tilt angle, orientation, position and immersion depth are corrected only by means of the first and second braking moment, in that, as explained above, a resultant force is generated. The weighting of the energy conversion control and position control is now described again with reference to this figure. An important aspect for the weighting is that the energy conversion control and the position control, for the calculation of the quantities \vec{y}¹, \vec{M}¹ and \vec{γ}², \vec{M}², respectively, are each given a control variable limitation. This is to be explained using the example of the control of the load angle 712 in FIG. 14. Despite a deviation between a specified value and an actual value of the load angle, the control variable Mₓ^{res} may not increase further beyond a certain magnitude. In addition, it is necessary to prevent a continued increase in variables within the control of the load angle, as soon as the control variable Mₓ^{res} has attained its maximum or minimum value, and there is nevertheless still a deviation between a specified value and an actual value of the load angle. Otherwise, a useful weighting of the quantities \vec{y}¹, \vec{M}¹ and \vec{γ}², \vec{M}² is not possible if, for example, the load angle control works contrary to the energy conversion control.

A variant having a more simplified position control is shown in FIG. 15. Here, the load angle, tilt angle and immersion depth are corrected only by means of the lift forces, i.e. adjustment parameters of the coupling bodies \vec{γ} and braking moments \vec{M}² are used only for the orientation in relation to the wave direction and for the position in the x and y directions. Moreover, for machine configurations that align themselves automatically in the wave direction because of special flow properties in combination with the mooring, the orientation control 714 may be omitted. In addition, for machines for locations with an insignificantly small drift flow, the position control 715x, 715y may also be omitted. This might possibly also remove the need for the weighting.

According to a further variant, the controls 712, 713 of the load angle and/or tilt angle may be omitted if the dynamics of the load angle and/or tilt angle is sufficiently damped, e.g. by damping plates, and the specified angular position of the machine is sufficiently stable because of appropriate, constant lift forces.

1. A method for operating a wave energy converter for converting energy from a wave motion of a fluid into a different form of energy, the wave energy converter including at least one rotor and at least one energy converter that is coupled to the at least one rotor, the method comprising:
generating with the wave motion a first torque that acts upon the at least one rotor; and
generating with the at least one energy converter a second torque that acts upon the at least one rotor,
wherein the second torque is specified in the course of an energy conversion control.

2. The method as claimed in claim 1, wherein the energy conversion control has a precontrol portion and a feedback control portion, wherein a mathematical model of the wave energy converter is used in the precontrol portion to specify specified values, and deviations between actual values and the specified values are corrected in the feedback control portion.

3. The method as claimed in claim 2, wherein the specification of the second torque comprises a superposed waveform of small amplitude, in order to improve the mathematical model, in that the result ensuing from a change in an adjustment parameter for the second torque is ascertained.

4. The method as claimed in claim 2, wherein the first torque is also specified in the course of the energy conversion control.

5. The method as claimed in claim 4, wherein the specification of the first torque comprises a superposed waveform of small amplitude, in order to improve the mathematical model, in that the result ensuing from a change in an adjustment parameter for the first torque is ascertained.

6. The method as claimed in claim 4, wherein the at least one rotor includes at least one coupling body used to generate the first torque from the wave motion through generation of a hydrodynamic lift force, and wherein one or more of a magnitude and a direction of the hydrodynamic lift force is specified by altering one or more of a position and a shape of the at least one coupling body.

7. The method as claimed in claim 6, wherein the specification of the one or more of the position and the shape of the at least one coupling body comprises a superposed waveform of small amplitude, in order to improve the mathematical model, in that the result ensuing from a change in the one or more of the position and the shape is ascertained.

8. The method as claimed in claim 1, wherein the wave motion is an orbital flow, and a rotational motion of the at least one rotor about the rotor axis is largely or completely synchronized with the orbital flow by specifying one or more of the first torque and the second torque.

9. The method as claimed in claim 8, wherein a phase angle between the orbital flow and the rotational motion of the at least one rotor is set or adjusted to a value or within a value range.

10. The method as claimed in claim 1, wherein the second torque is also specified in the course of a load control.

11. The method as claimed in claim 1, wherein the first torque is also specified in the course of a load control.

12. The method as claimed in claim 11, wherein a desired effective force, acting perpendicularly in relation to a rotation axis of the at least one rotor, is specified by specifying the first and the second torque in the course of the load control.

13. The method as claimed in claim 10, wherein the specifications of the first and/or second torque that ensue, respectively, in the course of the energy conversion control and in the course of the position control are combined, each having been given a weighting factor, to form a total specification of the first and/or second torque.

14. The method as claimed in claim 13, wherein the respective weighting factor is specified in dependence on an operating mode.

15. The method as claimed in claim 13, wherein, if a change in the machine position exceeds a position change threshold, the specification in the course of the position control is given more weight, and if a second torque falls below a lower moment threshold, the specification in the course of the energy conversion control is given more weight.

16. The method as claimed in claim 13, wherein the specifications of the first and second torque that ensue, respectively, in the course of the energy conversion control and in the course of the position control are subject to a control variable limitation.

17. The method as claimed in claim 10, wherein, in the course of the position control, at least one desired hydrostatic lift force, acting upon a frame of the wave energy converter, is additionally specified.

18. The method as claimed in claim 1, wherein the specification of the second torque comprises one or more of:
a specification of a constant braking moment M=M₀, wherein M₀ denotes a constant value;
a specification of a torque M=k(ω−w) that is dependent on a rotational speed ω of the rotor, wherein k denotes a controller parameter and w denotes a specified value;
a specification of a torque M=ƒₚ(Ψ) that is dependent on a rotational-angle position Ψ of the rotor, wherein ƒₚ(Ψ) denotes a function that is periodic in respect of the rotor revolution; and
a specification of a torque M=ƒₙₒₙₗᵢₙ²(ω,w,Ψ) that is dependent on a rotational speed ω of the rotor and on a rotational-angle position Ψ of the rotor, wherein ƒₙₒₙₗᵢₙ²(ω,w,Ψ) denotes a non-linear function and w is a specified value.

19. (canceled)

20. (canceled)

21. (canceled)

22. The method as claimed in claim 1, wherein local, regional and/or global incident flow conditions of the fluid in respect of the wave energy converter and/or its components, and/or an alignment of the wave energy converter, and/or a motion state of the wave energy converter, and/or a phase angle between an orbital flow and a rotational motion of the at least one rotor, are determined meteorologically or on the basis of modeling, in respect of time, as operating conditions, and used for the energy conversion control and/or position control.

23. A wave energy converter for converting energy from a wave motion of a fluid into a different form of energy, comprising:
at least one rotor; and
at least one energy converter coupled to the at least one rotor,
wherein the at least one rotor is configured to generate, from the wave motion, a first torque that acts upon the at least one rotor,
wherein the at least one energy converter is configured to generate a second torque that acts upon the at least one rotor, and comprising a control device, configured to specify the second torque in the course of an energy conversion control by corresponding control of the wave energy converter, and
wherein the control device is further configured to execute a method for operating the wave energy converter, the method including:
generating with the wave motion a first torque that acts upon the at least one rotor; and
generating with the at least one energy converter a second torque that acts upon the at least one rotor, and
specifying the second torque in the course of the energy conversion control.

24. (canceled)
